(19) United States
(12) Patent Application Publication
(10) Pub. No.: US 2006/0211428 A1
(43) Pub. Date: Sep. 21, 2006

(54) Communication system and mobile communication terminal

(75) Inventor: Masaru Shuto, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 11/283,133

(22) Filed: Nov. 19, 2005

(30) Foreign Application Priority Data
Mar. 17, 2005 (JP) 2005-77082

(51) Int. Cl. H04Q 7/20

(52) U.S. Cl. 455/450

(57) ABSTRACT

A communication system and a mobile communication terminal which are capable of receiving assignment of a high transmission rate upstream SCH (Supplement Channel). The mobile communication terminal requests assignment of an upstream SCH (step S11b), receives the transmission rate of the assigned SCH (step S11c), and if this transmission rate is not acceptable (namely, “unacceptable” in step S11d), then it requests release of the assigned SCH (step S11h) and again requests assignment of an upstream SCH (step S11i).

### CROSS-REFERENCE TO RELATED APPLICATIONS

This application is based upon and claims the benefit of priority from the prior Japanese Patent Application No. 2005-77082, filed on Mar. 17, 2005; the entire contents of which are incorporated herein by reference.

### BACKGROUND OF THE INVENTION

1. Field of the Invention

The present invention relates to a communication system and a mobile communication terminal, and more particularly, to a control processing for a data communication channel.

2. Description of the Related Art

In order to perform processes such as accessing electronic mails and web systems, transferring files, and the like, a mobile communication terminal communicates a large amount of data with a base station, and improvement in the through-put of this data communication is essential in order to improve the performance of the mobile communication terminal.

Therefore, as disclosed in Japanese Patent Application Laid-open No. 2001-45574, for example, it is known that a special channel for high transmission rate data communication (Supplement Channel, hereafter called “SCH”) may be used in addition to a basic channel (Fundamental Channel, hereafter called “FCH”) used for voice communication and data communication between a mobile communication terminal and a base station. The SCH is used for upstream communication (communication from a mobile communication terminal to a base station) and downstream communication (communication from a base station to a mobile communication terminal).

When the mobile communication terminal starts up processing for performing upstream data communication, the mobile communication terminal requests the base station to assign an upstream SCH. The assigned SCH is used at a designated transmission rate. In this case, the designated transmission rate is determined and assigned by the base station in accordance with the surplus channel resources available upon assignment. Processing is known whereby the base station changes the transmission rate dynamically if the designated transmission rate is not suitable (see, for example, Japanese Patent Application Laid-open No. 2004-32206 (page 2, FIG. 2)).

However, in the method disclosed in Japanese Patent Application Laid-open No. 2004-32206, there has been a problem in that it is not possible to assign an SCH set to a high transmission rate (hereafter, abbreviated as “high transmission rate SCH”, or the like), to a mobile communication terminal which is seeking to communicate a large amount of data in the upward direction. This is because although the mobile communication terminal knows the data volume that it wishes to communicate in the upstream direction, the base station cannot identify this data volume. Consequently, there has been a problem in that communication efficiency declines in a communication system comprising mobile communication terminals and base stations.

### SUMMARY OF THE INVENTION

In order to achieve the aforementioned object, an aspect of the present invention provides a communication system, in which a base station which assigns a channel for data communication and a mobile communication terminal which requests assignment of the channel are connected by means of a radio communication path; wherein the base station comprises: a request receiving unit which receives an assignment request for the channel specifying a transmission rate, transmitted by the mobile communication terminal; an assigning unit which assigns the channel having a transmission rate determined based upon the transmission rate specified in the assignment request and available channel resources, in response to the assignment request received by the request receiving unit; an assignment reporting unit which transmits information including the transmission rate of the channel assigned by the assigning unit, to the mobile communication terminal; a release request receiving unit which receives a release request for the channel assigned by the assigning unit, from the mobile communication terminal; and a releasing unit which releases the channel received by the release request receiving unit; and the mobile communication terminal comprises: a request transmitting unit which transmits the assignment request for a channel designating the transmission rate, to the base station; an assignment report receiving unit which receives information including the transmission rate of the assigned channel, from the base station; a release request transmitting unit which transmits the release request for the channel received by the assignment report receiving unit, to the base station; and a channel control unit which judges whether or not the transmission rate received by the assignment report receiving unit can be accepted, and if it cannot be accepted, controls the release request transmitting unit so as to transmit the release request for the assigned channel, and controls the request transmitting unit so as to transmit the assignment request for the channel specifying the transmission rate, thereby issuing a repeat channel assignment request.

According to the above-mentioned aspect of the present invention, it is possible to provide a communication system and the mobile communication terminal whereby the mobile communication terminal can receive assignment of a high transmission rate upstream SCH (Supplement Channel).

### BRIEF DESCRIPTION OF THE DRAWINGS

FIG. 1 is a block diagram showing the composition of a communication system relating to an embodiment of the present invention;

FIG. 2 is a block diagram showing the composition of a mobile communication terminal relating to an embodiment of the present invention;

FIG. 3 is a block diagram showing the composition of a base station relating to an embodiment of the present invention;

FIG. 4 is a flowchart showing a control operation for assignment of an FCH and SCH performed by the control unit of the base station relating to an embodiment of the present invention;

FIG. 5 is a flowchart showing a control operation for an SCH assignment request performed by the control unit of the mobile communication terminal relating to an embodiment of the present invention;

FIGS. 6A and 6B show one example of the time interval at which an SCH assignment request is repeated by the control unit of the mobile communication terminal relating to an embodiment of the present invention; and

FIG. 7 shows one example of the flow of communication in a communication system relating to an embodiment of the present invention.

### DETAILED DESCRIPTION OF THE INVENTION

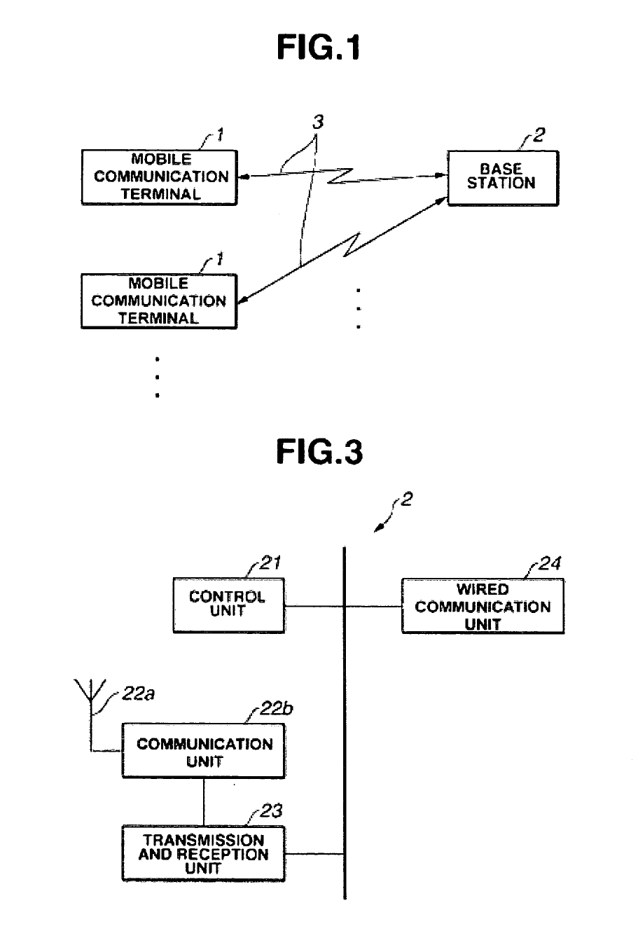

An embodiment of a communication system and a mobile communication terminal according to the present invention will be described with reference to the drawings. FIG. 1 is a block diagram showing the configuration of a communication system relating to an embodiment of the present invention. This communication system comprises a plurality of mobile communication terminals 1 relating to the embodiment of present invention, a base station 2, and channels 3 including FCH and SCH which are used for communication between the mobile communication terminal 1 and the base station 2.

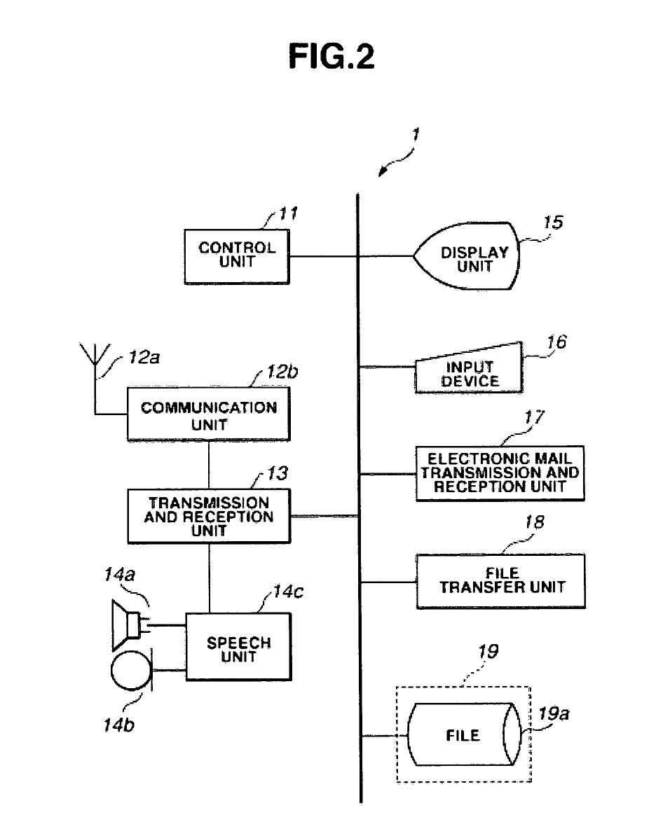

FIG. 2 is a block diagram showing an example of the configuration of the mobile communication terminal 1. This mobile communication terminal 1 comprises: a control section 11 for controlling the whole mobile communication device 1, an antenna 12a for transmitting and receiving radio waves to and from the base station 2, a communication unit 12b, a transmission and reception unit 13, a speaker 14a, a microphone 14b, a speech unit 14c, a display unit 15, an input device 16, an electronic mail transmission and reception unit 17, a file transfer unit 18, and a file storage unit 19. A file 19a is stored in the file storage section 19.

FIG. 3 is a block diagram showing an example of the configuration of the base station 2. The base station 2 comprises a control unit 21 for controlling the whole device, an antenna 22a for transmitting and receiving radio waves to and from a mobile communication terminal 1, a transmission 22b and reception unit 23, and a wired communication unit 24.

Here, the operation of each section of the communication system is described, starting from the operation of the sections constituting the mobile communication terminal 1.

The communication unit 12b outputs a high-frequency signal received by the antenna 12a, to the transmission and reception unit 13 and transmits a high-frequency signal output from the transmission and reception unit 13, to the base station 2 via the antenna 12a. The transmission and reception unit 13 executes amplification of, conversion of, and demodulation of the high-frequency signal from the communication unit 12b sequentially, and generates digital voice signal, digital data signal, and control signal. Then, the digital voice signal is output to the speech unit 14c, and digital data signal and control signal are output to the control unit 11. On the other hand, digital voice signal output from the speech unit 14c and, and digital data signal and control signal output from the control unit 11 are executed modulation, frequency-conversion, and amplification sequentially at the transmission and reception unit 13. Then, the transmission and reception unit 13 outputs a high-frequency signal to the communication unit 12b.

The speech unit 14c converts the digital voice signal output from the transmission and reception unit 13 into an analogue voice signal, amplifies the signal and sends it to the speaker 14a. Moreover, the speech unit 14c also amplifies a voice signal output from the microphone 14b and converts the amplified voice signal into a digital voice signal. Then, the speech unit 14c sends the digital voice signal to the transmission and reception unit 13.

Thereupon, the display unit 15 displays text, figures, image data, and the like, under the control of the control unit 11, and the data thus displayed is switched in response to an input operation from the input device 16 or an incoming signal.

The input device 16 consists of keys which include keys for inputting a telephone number, the subject and text of an electronic mail, a destination address, and the like, as well as a plurality of function keys. When the keys of this input device 16 are operated, the identifiers of the keys are inputted to the control unit 11 and are displayed as characters, such as text or the like, on the display unit 15 by means of the control unit 11. Furthermore, control is implemented on the basis of the functions corresponding to these identifiers.

Next, the electronic mail transmission and reception unit 17 starts an electronic mail reception operation by means of the control unit 11 starting up when the control unit 11 has received an electronic mail reception signal. Thereupon, the subject and text of an incoming mail received by the control unit 11 is received and stored in the electronic mail transmission and reception unit 17. Moreover, if a file is attached to the incoming mail, then this file attachment is also received and stored as a file 19a in the file storage unit 19.

If an electronic mail reading function has been selected by means of a prescribed key operation in the input device 16, the electronic mail transmission and reception unit 17 is started up by the control unit 11 and the subject and text of a received mail stored in the electronic mail transmission and reception unit 17 are displayed on the display unit 15.

Furthermore, if a file is attached to an incoming mail and a prescribed key is operated, then the electronic mail transmission and reception unit 17 reads out the file 19a in which attached file data is stored, from the file storage unit 19. If the file 19a is a content file consisting of encoded video data and voice data, for example, then the content is decoded by a decoding unit (not shown), and the decoded content is output to the display unit 15 and the speaker 14a.

Furthermore, if an electronic mail transmission function has been selected by means of a prescribed key operation in the input device 16, the electronic mail transmission and reception unit 17 is started up by the control unit 11 and the subject and text of the outgoing mail are input by operating prescribed keys of the input device 16. Moreover, if attachment of a file is instructed by operating prescribed keys of the input device 16, then the designated file 19a is read out from the file storage unit 19 and handled as a file attachment. The electronic mail transmission and reception unit 17 sends a transmission instruction for the electronic mail to be transmitted, to the control unit 11.

The file transfer unit 18 is started up by the control unit 11, in accordance with the operation of prescribed keys in the input device 16, and it transfers the file 19a in the upstream direction or the downstream direction. If the identifier of a file 19a, the identifier of a transfer destination device (not shown) and a transfer direction are instructed by operating prescribed keys of the input device 16, then a file transfer instruction is sent to the control unit 11 in accordance with these instructions.

Next, the operations of the respective sections constituting the base station 2 are described. The communication unit 22b outputs a high-frequency signal received by the antenna 22a to the transmission and reception unit 23, and transmits a high-frequency signal output from the transmission and reception unit 23 via the antenna 22a.

The transmission and reception unit 23 amplifies the high-frequency signal from the communication unit 22b, converts the frequency of the signal and modulates the signal. It sends the digital voice signal and the digital data signal thus obtained to the wired communication unit 24, and also sends a control signal to the control unit 21. Furthermore, the digital voice signal and the digital data signal output from the wired communication unit 24 and a control signal output by the control unit 11 are modulated, their frequencies are converted and the signals are amplified, thereby obtaining a high-frequency signal which is sent to the communication unit 22b.

The wired communication unit 24 sends the digital voice signal and the digital data signal output from the transmission and reception unit 23, and the control signal output by the control unit 21, to an exchange station (not shown), via a wired communication network (not shown). Furthermore, a digital voice signal and a digital data signal output from the exchange station via the wired communication network is transmitted to the transmission and reception unit 23, and a control signal output from the exchange station via the wired communication network is sent to the control unit 21.

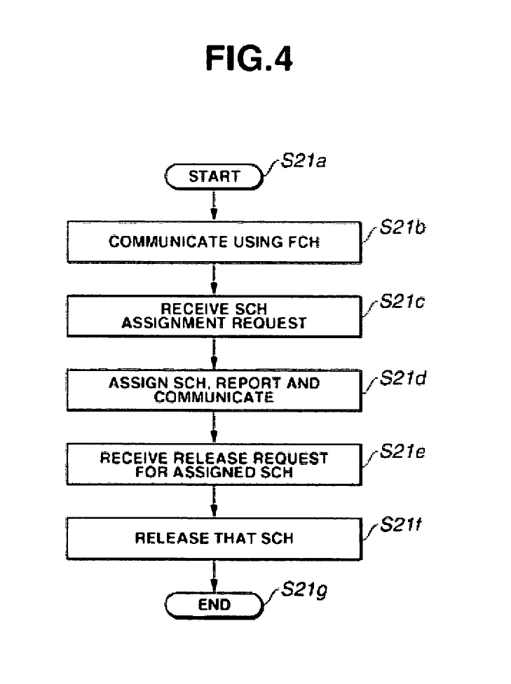

Next, an operation of controlling the assignment of an FCH and an upstream SCH as implemented by the control unit 21 of the base station 2, will be described. FIG. 4 shows a flowchart of a control operation performed by the control unit 21 in order to assign an FCH and upstream SCH. The control unit 21 starts operation upon receiving a control signal indicating origination of voice or data communication transmitted by the mobile communication terminal 1, or upon receiving a control signal indicating reception of voice or data communication transmitted by an exchange station, in the mobile communication terminal 1. The control unit 21 assigns an FCH between the base station 2 and the mobile communication terminal 1 (step S21a), and then performs voice or data communication using that FCH (step S21b).

Furthermore, upon receiving an upstream SCH request transmitted by the mobile communication terminal 1 (step S21c), the control unit 21 assigns an SCH between the base station 2 and the mobile communication terminal 1 in accordance with this request and transmits information relating to the assigned SCH, including the transmission rate of the SCH, to the mobile communication terminal 1, and performs upstream data communication using this SCH (step S21d). The transmission rate of the SCH is determined based upon a requested transmission rate included in the SCH request from the mobile communication terminal 1, and the spare channel resources available.

If the control unit 21 receives a request from the mobile communication terminal 1 to release the assigned SCH (step S21e), then the control unit 21 releases the SCH in accordance with this request (step S21f). Furthermore, if the voice or data communication with the mobile communication terminal 1 has been completed, then the assigned FCH is released and the channel assignment operation is terminated (step S21g).

Moreover, in accordance with a downstream SCH assignment request from the exchange station, the control unit 21 assigns an SCH between the base station 2 and the mobile communication terminal 1 and performs downstream data communication using this SCH. The transmission rate of this SCH is determined on the basis of the request from the exchange station and the spare channel resources available. Moreover, the SCH is released in accordance with a request from the exchange station to release the assigned SCH.

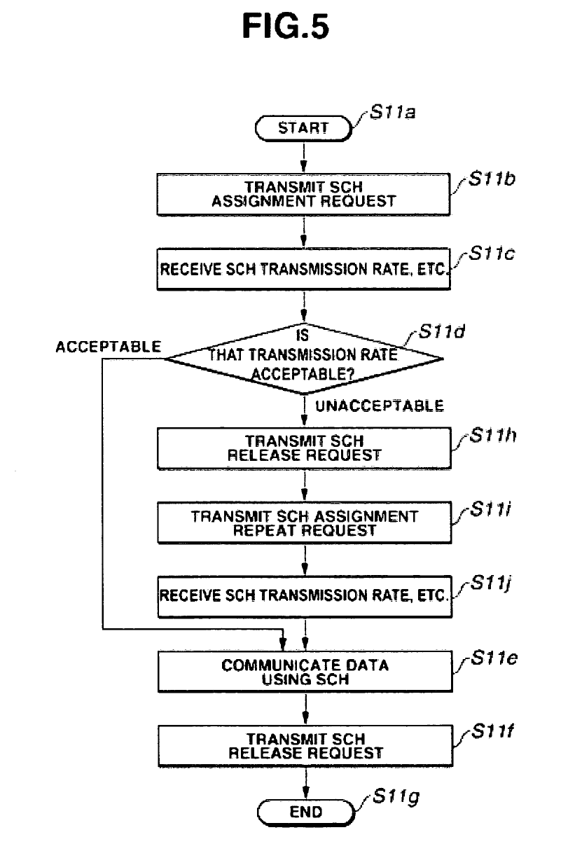

Next, the operations performed by the control unit 11 of the mobile communication terminal 1 in controlling the request and release of an upstream SCH, and communication using this SCH, will be described. FIG. 5 shows a flowchart of the operations performed by the control unit 11 in controlling the request and release of an upstream SCH, and communication using this SCH. The control operations performed by the control unit 11 in relation to request and release of an upstream SCH and communication using this SCH are started upon receiving a command from the electronic mail transmission and reception unit 17 or the file transfer unit 18 instructing upstream data communication (step S11a).

Thereupon, the control unit 11 sends a request for assignment of an upstream SCH with a transmission rate determined on the basis of the data amount to be communicated, to the base station 2 (step S11b). Then, the mobile communication terminal 1 receives information on the SCH including the transmission rate of the assigned SCH from the base station 2 (step S11c), and compares this transmission rate with the data amount to be communicated in order to examine whether or not the transmission rate is acceptable. In other words, the mobile communication terminal 1 checks whether or not this transmission rate is a sufficiently high transmission rate in order to communicate data of that amount (step S11d).

Here, the greater the data amount, the higher the acceptable transmission rate, but the invention is not limited to this. For example, if the assigned transmission rate is a prescribed rate or above, then the transmission rate may be judged to be acceptable, and if the assigned transmission rate is less than a prescribed rate, then the transmission rate may be judged to be unacceptable. Furthermore, the control unit 11 may request assignment of an SCH of the highest transmission rate, and if the assigned transmission rate is this highest rate, then the control unit 11 may judge the transmission rate to be acceptable, whereas if the assigned rate is not this highest rate, then the control unit 11 may judge the transmission rate to be unacceptable.

If the transmission rate is acceptable, then the control unit 11 performs data communication using the assigned SCH (step S11e), and after transmitting a prescribed number of blank frames using the assigned SCH, the control unit 11 sends an SCH release request (step S11f) and terminates the operation (step S11g).

At step S11d, if the transmission rate of SCH is not acceptable, then the control unit 11 transmits a prescribed number of blank frames using the assigned SCH, and then transmits a release request for that SCH (step S11h). The control unit 11 sends a repeat request for assignment of an upstream SCH having a transmission rate determined on the basis of the data amount to be communicated, to the base station 2 (step S11i). The transmission rate of the assigned SCH, and the like, is received from the base station 2 (step S11j).

The operation in step S11h, the operation in step S11i and the operation in step S11j are respectively similar to the operation in step S11f, the operation in step S11b and the operation in step S11c.

The control unit 11 then performs data communication using the SCH (step S11e), and after transmitting a prescribed number of blank frames using the assigned SCH, the control unit 11 sends an SCH release request (step S11f), and terminates the operation (step S11g).

Here, the number of blank frames transmitted by the control unit 11 at step S11f and step S11h is a number that is determined in order to release an SCH that has been assigned on an indefinite basis, and this number is received at the same time as the information on the transmission rate, or the like, of the assigned SCH received at step S11c or step S11j.

In the aforementioned description, it is supposed that, at step S11j, the control unit 11 receives the transmission rate of the SCH assigned in response to the request transmitted at step S11i and does not examine whether or not that rate is acceptable by comparing the rate with the amount of the data to be communicated. In other words, this comparison is only performed once at step S11d, and the repeat request for assignment of SCH is only performed once at step S11i, but the invention is not limited to this.

For example, after receiving the transmission rate of the assigned SCH from the base station 2 at step S11j, the procedure may transfer to the operation in step S11d a prescribed number of times, perform the aforementioned comparison, and implement a repeat request if the transmission rate of SCH is not acceptable. The aforementioned number of times may be set to a larger number, the greater the amount of the data that is to be communicated. Furthermore, it may also be set to a larger number, the slower the transmission rate of the assigned SCH. Furthermore, the time interval at which the aforementioned steps of comparison and repeat request are repeated may be set to a shorter interval, the slower the transmission rate of the assigned SCH, and it may be set to a longer interval, the greater the number of repetitions made.

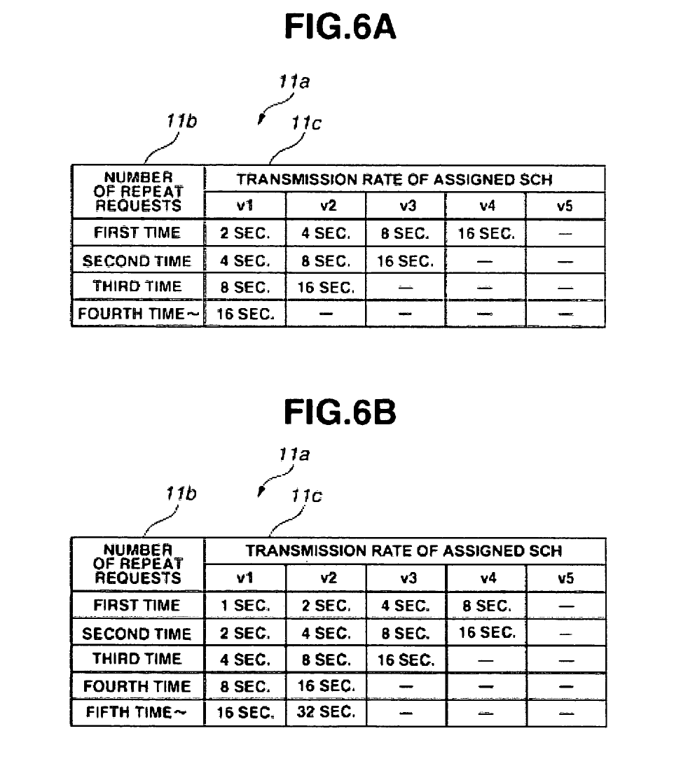

FIG. 6 shows one example of the time interval and number of times for repeating the aforementioned repeat request, in the form of a table; FIG. 6A shows one example of a case where the data amount to be communicated is less than a prescribed value, and FIG. 6B shows one example of a case where the data amount to be communicated is greater than a prescribed value. The repeat request interval 11a is determined on the basis of various factors, namely, the number of repeat requests 11b, the transmission rate of the assigned SCH 11c, and the maximum transmission rate of SCH. Here, it is supposed that the values of the transmission rate 11c of the assigned SCH are set to dispersed values, namely v1-v5, where v1<v2<v3<v4<v5. In other words, the maximum transmission rate of the SCH is v5. Furthermore, it is also assumed that the control unit 11 has judged that the transmission rate v5 is an acceptable rate.

If the data amount to be communicated shown in FIG. 6A is less than the prescribed value, then the time interval when the number of repeat requests 11b is 1, namely, the time interval from the request for assignment of an SCH at step S11b until the time at which a repeat request for assignment of an SCH is performed for a first time at step S11i, will be 2 seconds if the transmission rate 11c of the assigned SCH received at step S11c is v1, 4 seconds, if the transmission rate is v2, 8 seconds, if the transmission rate is v3, and 16 seconds, if the transmission rate is v4. If the transmission rate is v5, then a repeat request is not performed.

The time interval when the number of repeat requests 11b is 2, in other words, the time interval until a repeat request for assignment of an SCH is performed for a second time at step S11i, will be 4 seconds if the transmission rate 11c of the assigned SCH received at step S11j on the first occasion is v1, 8 seconds, if the transmission rate is v2, and 16 seconds, if the transmission rate is v3. If the transmission rate is v4 or v5, then another repeat request is not performed.

The time interval when the number of repeat requests 11b is 3, in other words, the time interval until a repeat request for assignment of an SCH is performed for a third time at step S11i, will be 8 seconds if the transmission rate 11c of the assigned SCH received at step S11j on the second occasion is v1, and 16 seconds, if the transmission rate is v2. If the transmission rate is v3, v4 or v5, then another repeat request is not performed.

The time interval when the number of repeat requests 11b is 4 or above, in other words, the time interval until a repeat request for assignment of an SCH is performed for a fourth or greater time at step S11i, will be 16 seconds if the transmission rate 11c of the assigned SCH received at step S11j on the previous occasion is v1. If the transmission rate is v2, v3, v4 or v5, then another repeat request is not performed.

If the data amount to be communicated shown in FIG. 6B is greater than the prescribed value, then the time interval when the number of repeat requests 11b is 1, namely, the time interval from the request for assignment of an SCH at step S11b until the time at which a repeat request for assignment of an SCH is performed for a first time at step S11i, will be 1 second if the transmission rate 11c of the assigned SCH received at step S11c is v1, 2 seconds, if the transmission rate is v2, 4 seconds, if the transmission rate is v3, and 8 seconds, if the transmission rate is v4. If the transmission rate is v5, then a repeat request is not performed.

The time interval when the number of repeat requests 11b is 2, in other words, the time interval until a repeat request for assignment of an SCH is performed for a second time at step S11i, will be 2 seconds if the transmission rate 11c of the assigned SCH received at step S11j on the first occasion is v1, 4 seconds, if the transmission rate is v2, 8 seconds, if the transmission rate is v3, and 16 seconds, if the transmission rate is v4. If the transmission rate is v5, then another repeat request is not performed.

The time interval when the number of repeat requests 11b is 3, in other words, the time interval until a repeat request for assignment of an SCH is performed for a third time at step S11i, will be 4 seconds if the transmission rate 11c of the assigned SCH received at step S11j on the second occasion is v1, 8 seconds, if the transmission rate is v2, and 16 seconds, if the transmission rate is v3. If the transmission rate is v4 or v5, then another repeat request is not performed.

The time interval when the number of repeat requests 11b is 4, in other words, the time interval until a repeat request for assignment of an SCH is performed for a fourth time at step S11i, will be 8 seconds if the transmission rate 11c of the assigned SCH received at step S11j on the third occasion is v1, and 16 seconds, if the transmission rate is v2. If the transmission rate is v3, v4 or v5, then another repeat request is not performed.

The time interval when the number of repeat requests 11b is 5 or above, in other words, the time interval until a repeat request for assignment of an SCH is performed for a fifth or greater time at step S11i, will be 16 seconds if the transmission rate 11c of the assigned SCH received at step S11j on the previous occasion is v1, and 32 seconds, if the transmission rate is v2. If the transmission rate is v3, v4 or v5, then another repeat request is not performed.

By determining the repeat request interval 11a or determining that a repeat request is not to be performed, as described above, then the slower the transmission rate 11c of the assigned SCH, the shorter the repeat request interval 11a and the greater the number of times that a repeat request is performed. Furthermore, the greater the number of repeats, the longer the repeat request interval 11a at which repeat requests are performed.

Furthermore, the greater the data amount to be communicated, the shorter the repeat request interval 11a and the greater the number of repeat requests performed. Here, the data amount is compared in magnitude with the prescribed value, and one set of repeat request intervals 11a and repeat request numbers is selected from two sets, accordingly, but the invention is not limited to this. It is also possible to select from three or more sets of values, and it is also possible to calculate the repeat request interval 11a and the number of repeat requests, as a function of the aforementioned data amount. Furthermore, it is also possible to determine either one or both of the repeat request interval 1a and the number of repeat requests independently of the data amount.

Thereby, it is possible to increase the possibility of the control unit 11 receiving assignment of an SCH of higher transmission rate, by means of a repeat request. Moreover, it is possible to avoid carrying out a repeat request, if there is little or no possibility of receiving assignment of an SCH of higher transmission rate.

The control unit 11 may take the transmission rate of the upstream SCH requested at step S11b and step S11i to be a maximum rate (v5) at all times. Furthermore, this rate may be determined in accordance with the state of radio wave propagation. In other words, if the state of radio wave propagation is good, then it is possible to request a slower transmission rate in comparison with a case where the state of propagation is poor.

Furthermore, the control unit 11 performs data communication with the aforementioned repeat request interval 11a using the assigned SCH. Moreover, during the SCH release and repeat request operations in step S11h to step S11j, the control unit 11 performs data communication using the FCH.

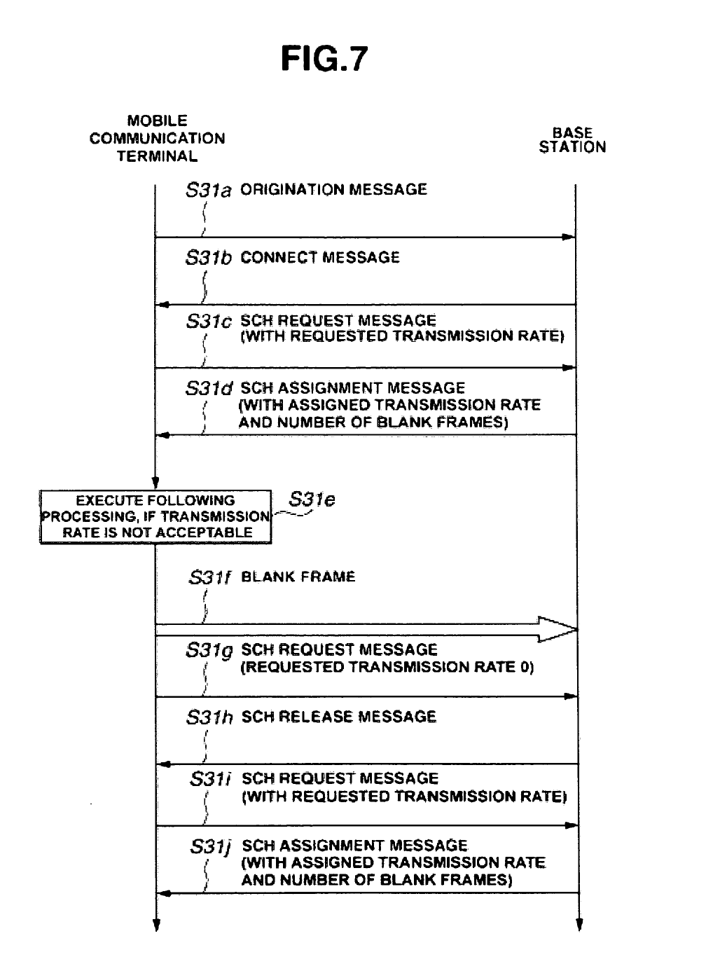

Next, one example of communication relating to SCH request and assignment as performed between the mobile communication terminal 1 and the base station 2. FIG. 7 shows one example of the flow of communication relating to SCH request and assignment as performed between the mobile communication terminal 1 and the base station 2.

The communication relating to SCH request and assignment performed between the mobile communication terminal 1 and the base station 2 are started by means of the mobile communication terminal 1 sending a communication start message (Origination Message) to the base station 2 (step S31a). In the response to this, the base station 2 sends a connection message (Connect Message) to the mobile communication terminal 1 and confirms the communication interface (step S31b).

Subsequently, the mobile communication terminal 1 sends a SCH request message (SCRM, Supplement Channel Request Message) to the base station 2. This message includes the requested transmission rate of the SCH (step S31c. Steps S31a to S31c correspond to step S21c shown in FIG. 4 and step S11b shown in FIG. 5).

In response to this, the base station 2 sends an SCH assignment message (ESCAM, Extended Supplement Channel Assignment Message), to the mobile communication terminal 1. This message includes the transmission rate of the assigned SCH, and the number of blank frames transmitted by the mobile communication terminal 1 upon release of the SCH (step S31d, which corresponds to step S21d shown in FIG. 4 and step S11c shown in FIG. 5). This message may also include the time period for which the SCH is assigned to the mobile communication terminal 1.

Thereupon, the mobile communication terminal 1 judges whether or not the transmission rate of the assigned SCH is acceptable, and if the rate is not acceptable, then the following processing is implemented (step S31e, which corresponds to the “unacceptable” branch at step S11d shown in FIG. 5).

In other words, the mobile communication terminal 1 firstly sends blank frames according to the number of blank frames received at step S31d, to the base station 2 (step S31f), whereupon it requests the release of the assigned SCH by sending a SCH request message (SCRM) in which the requested transmission rate of SCH is zero (step S31g) to the base station 2. (Steps S31f to S31g correspond to step S21e in FIG. 4 and step S11h in FIG. 5).

In response to this, the base station 2 sends a message reporting the release of the assigned SCH to the mobile communication terminal 1, in the form of an SCH assignment message (ESCAM) having an assignment time of zero (step S31h, which corresponds to step S21f shown in FIG. 4).

Subsequently, the mobile communication terminal 1 sends an SCH request message (SCRM) to the base station 2 (step S31i, which corresponds to step S21c shown in FIG. 4 and step S11i shown in FIG. 5). In response to this, the base station 2 sends an SCH assignment message (ESCAM) to the mobile communication terminal 1 (step S31j, which corresponds to step S21d shown in FIG. 4 and step S31j shown in FIG. 5). The communication performed in steps S31i and S31j are similar to those performed in steps S31c and S31d, and detailed description thereof is omitted here.

In the foregoing description, the mobile communication terminal 1 requests assignment of an upstream SCH to the base station 2, whereas assignment of a downstream SCH is requested from the exchange station to the base station 2. However, the invention is not limited to this. It is also possible for the mobile communication terminal 1 to request assignment of a downstream SCH, and it is also possible for the exchange station to request assignment of an upstream SCH. The invention is not limited to the composition described above, and various modifications are possible.

What is claimed is:

1. A communication system, in which a base station which assigns a channel for data communication and a mobile communication terminal which requests assignment of the channel are connected by means of a radio communication path;
wherein the base station comprises:
a request receiving unit which receives an assignment request for the channel specifying a transmission rate, transmitted by the mobile communication terminal;
an assigning unit which assigns the channel having a transmission rate determined based upon the transmission rate specified in the assignment request and available channel resources, in response to the assignment request received by the request receiving unit;
an assignment reporting unit which transmits information including the transmission rate of the channel assigned by the assigning unit, to the mobile communication terminal;
a release request receiving unit which receives a release request for the channel assigned by the assigning unit, from the mobile communication terminal; and
a releasing unit which releases the channel received by the release request receiving unit; and
the mobile communication terminal comprises:
a request transmitting unit which transmits the assignment request for a channel designating the transmission rate, to the base station;
an assignment report receiving unit which receives information including the transmission rate of the assigned channel, from the base station;
a release request transmitting unit which transmits the release request for the channel received by the assignment report receiving unit, to the base station; and
a channel control unit which judges whether or not the transmission rate received by the assignment report receiving unit can be accepted, and if it cannot be accepted, controls the release request transmitting unit so as to transmit the release request for the assigned channel, and controls the request transmitting unit so as to transmit the assignment request for the channel specifying the transmission rate, thereby issuing a repeat channel assignment request.

2. A mobile communication terminal for a communication system in which a base station, which assigns a channel for data communication in response to a channel assignment request; comprising:
a request transmitting unit which transmits the assignment request for the channel designating the transmission rate, to the base station;
an assignment report receiving unit which receives information including the transmission rate of the assigned channel, from the base station;
a release request transmitting unit which transmits the release request for a channel received by the assignment report receiving unit, to the base station; and
a channel control unit which judges whether or not the transmission rate received by the assignment report receiving unit can be accepted, and if it cannot be accepted, controls the release request transmitting unit so as to transmit the release request for the assigned channel, and controls the request transmitting unit so as to transmit the assignment request for the channel specifying the transmission rate, thereby issuing a repeat channel assignment request.

3. The mobile communication terminal according to claim 2, wherein the channel control unit performs the repeat channel assignment request, judges whether or not the transmission rate received by the assignment reporting unit in response to this request is acceptable, and if the transmission rate is not acceptable, performs the repeat channel assignment request again, for a prescribed number of repetitions.

4. The mobile communication terminal according to claim 3, wherein the prescribed number of repetitions becomes high as a degree of unacceptability of the transmission rate increases.

5. The mobile communication terminal according to claim 3, wherein a time interval at which the repeat channel assignment request is repeated becomes short as a degree of unacceptability of the transmission rate increases.

6. The mobile communication terminal according to claim 3, wherein a time interval at which the repeat channel assignment request is repeated becomes long as each time the repeat channel assignment request is repeated.
